(19) United States
(12) Patent Application Publication
(10) Pub. No.: US 2005/0196325 A1
(43) Pub. Date: Sep. 8, 2005

(54) Arrangement for the evaluation of fluorescence-based detection reactions

(76) Inventors: Wolfgang Bathe, Jena (DE); Peter Kuehn, Jena (DE); Dieter Schau, Nerkewitz (DE); Alexander L. Friedman, Pittsburgh, PA (US); Albert H. Gough, Glenshaw, PA (US)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/109,898

(22) Filed: Apr. 19, 2005

Related U.S. Application Data
(63) Continuation of application No. 09/959,028, filed on Mar. 28, 2002, now abandoned.

(30) Foreign Application Priority Data
Apr. 14, 1999 (DE) 199 16 748.6

(51) Int. Cl. G01N 21/00

(52) U.S. Cl. 422/82.08; 436/172

(57) ABSTRACT

Arrangement for the evaluation of fluorescence-based detection reactions in transparent specimen vessels, wherein the excitation and imaging of the fluorescence is carried out through the vessel bottom, and the specimens are introduced from above, wherein an adjustable cover is provided which closes the top of the specimen vessels and which has at least one opening for introducing specimens and which is positioned above the specimen vessels provided for filling only during the filling process and/or is opened only during the filling process.

### CROSS-REFERENCE TO RELATED APPLICATIONS

This application is a continuation application of U.S. patent application Ser. No. 09/959,028 filed Mar. 28, 2002, which claims priority of International Application No. PCT/EP00/03307, filed Apr. 13, 2000, and German Application No. 199 16 748.6, filed Apr. 14, 1999, the complete disclosures of which are hereby incorporated by reference.

### FIELD OF THE INVENTION

The invention is directed to an arrangement for the evaluation of fluorescence-based detection reactions.

The invention more particularly is directed to an arrangement for an inverted automatic single-channel fluorescence microscope with an autofocus system and a climate-controlled specimen chamber. An image is generated by a CCD camera and analyzed subsequently by image analysis software. The specimens are cells (in solution) at the bottom of microtiter plates (MTP). The MTPs are supplied automatically or manually and the autofocus system focuses on the solution/MTP-bottom interface. After focusing has been accomplished and the excitation filter has been selected, the dyes in the specimen are excited by means of an XBO lamp or HBO lamp. The fluorescent light of the specimen passes the selected emission filter and the specimen is imaged on the CCD camera. After the image is recorded, excitation filters and emission filters are possibly changed and a new image is recorded. Subsequently, the image is evaluated, the XY scanning table moves to the next image field or to the next MTP vessel, the autofocus is activated again, and the sequence begins anew.

### BRIEF DESCRIPTION OF THE DRAWINGS

In the drawings:

FIG. 1 shows a schematic view of the entire arrangement;

FIG. 2 shows the climate control system; and

FIG. 3 shows a perspective view with the cover drive.

### DESCRIPTION OF THE PREFERRED EMBODIMENTS

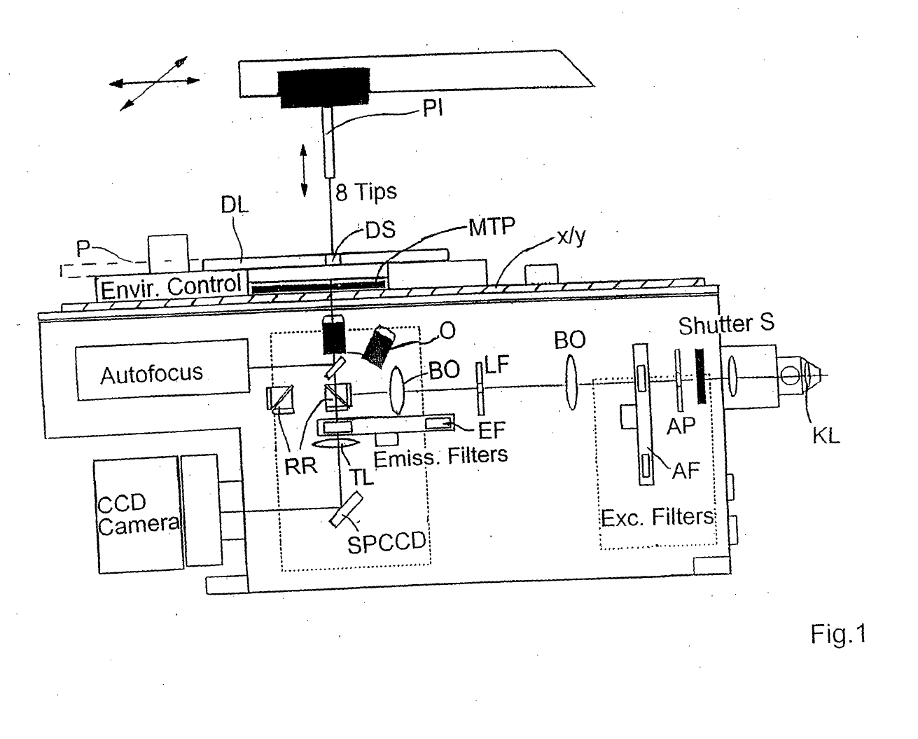

A pipettor which is displaceable (for filling with the specimen) and which can be lowered (for dispensing the specimen) is shown in FIG. 1 and is used for pipetting into the individual specimen vessels of the MTP.

For this purpose, after it has been introduced into the microscope via a feed system, for example, a turntable, the MTP is displaced with its provided filling openings by means of the X/Y table over the objective O and under the pipettor PI.

A displaceable cover DL is provided with a filling slot DS above the MTP supported in a chamber KA. The MTP is arranged so as to be displaceable with the chamber KA and the cover DL on an X/Y table.

A parked position of the cover DL in which the filling slot DS is not located over the openings of the MTP so that the climatic conditions in the chamber are not disturbed is shown schematically.

The time sequence is as follows:

The MTP is supplied, for example, via turntable (not shown, prior art).

A closure flap VK, concealed in FIG. 8, indicated by the arrow, goes up, the plate is supplied. The cover is closed.

The X/Y table moves the MTP into the pipetting position over the objective.

Two variants are advantageously possible:

1. A plurality of pipetted vessels of the MTP arranged in a row are moved over the objective and evaluated successively.

2. Pipetting is always carried out only in one vessel, followed immediately by evaluation and the next vessel is then pipetted and evaluated, which is very important for rapidly running processes (reactions with fast kinetics).

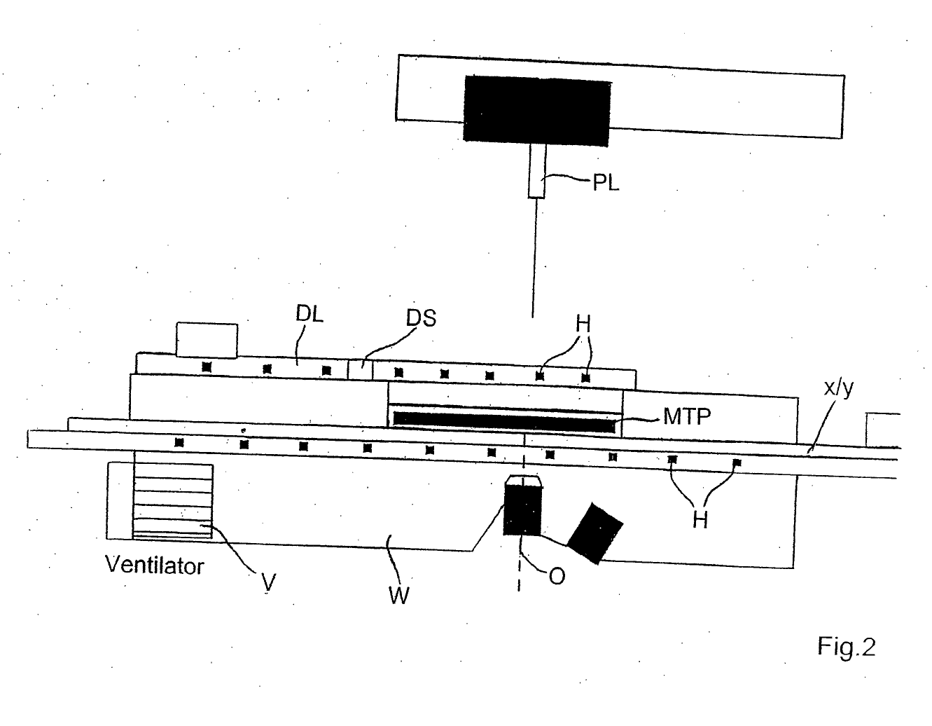

Further, heating elements HS (see FIG. 2) are provided in the cover and on the underside of the MTP, and a ventilator V for supplying warm air for adjusting a stable climate is provided in a trough W with temperature control below the table X/Y, which is advantageous for measurements of living cells, for example.

The warm air also reaches the surroundings of the microtiter plate MTP via the optical opening at the objective O.

For pipetting, the cover DL is displaced in such a way that the slot DS is located in a position over a row of vessels of the MTP in which pipetting is to be carried out. The pipettor with liquid (which was taken up beforehand) dips into the slot, dispenses liquid and is raised again and the cover is immediately closed.

The small cover opening and the fast opening and closing advantageously produces a thermal equilibrium which persists during the filling with the specimens, also due to the heating and ventilator. Very fast processes can be detected due to the possibility of pipetting directly in the reader, since the microtiter plate need not be moved back and forth.

Finally, a climate chamber which comprises the MTP, heating and cover modules and which is displaceable in the optical axis of the evaluating means with respect to the analyzed specimen can be realized on the reader. Accordingly, the temperature conditions and CO₂ conditions can be maintained in a monitored and reproducible manner particularly for assays with living cells.

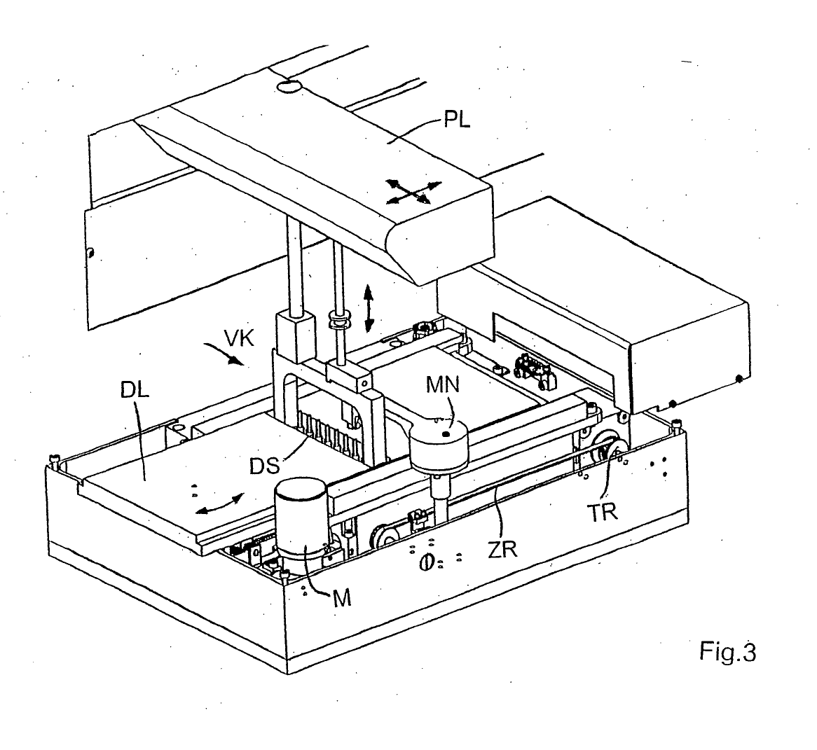

Further, the cover drive by means of a toothed belt ZR and driver MN is shown in FIG. 3 in a perspective schematic view. M represents the motor of the toothed belt drive.

While the foregoing description and drawings represent the present invention, it will be obvious to those skilled in the art that various changes may be made therein without departing from the true spirit and scope of the present invention.

### REFERENCE NUMBERS

pipettor PI
microtiter plate MTP
cover DL
cover opening DS
table X/Y
parked position P
heating elements H
ventilator V
toothed belt ZR
driver MN
motor M
chamber KA
closure flap KK
trough W

1-5. (canceled)

6. An arrangement for the evaluation of fluorescence-based detection reactions in microtiter plates comprising:
said microtiter plates having transparent specimen vessels;
excitation and imaging of the fluorescence being carried out through a bottom of a vessel and the specimens being introduced from above;
a horizontally displaceable cover being provided which closes the top of the specimen vessels and which has at least one opening for introducing specimens and which is located over openings of the microtiter plate only during the filling process and is otherwise arranged in a parked position in which the filling opening is not located over the specimen vessels.

7. The arrangement according to claim 6, wherein the lowering direction of a pipetting device, the opening of the cover and the optical axis of the excitation/evaluation substantially coincide in the filling position.

8. The arrangement according to claim 6, wherein means are provided for climate control of the microtiter plates.

9. The process for operating an arrangement according to claim 6, wherein a plurality of pipetted specimen vessels which are arranged in a row are moved over the objective and evaluated one after the other after closing the cover.

10. The process for operating an arrangement according to claim 6, wherein pipetting is always carried out only in a specimen vessel, followed immediately by evaluation after closing the cover, and the next pot is then pipetted and evaluated.

11. A method for evaluating fluorescence-based detection reactions in microtiter plates comprising the steps of:
carrying out excitation and imaging of fluorescence through a bottom of a vessel;
introducing specimens from a top of the vessel; and
closing the top of the specimen vessels with a displaceable cover having at least one opening for introducing the specimens.
